(19) United States
(12) Patent Application Publication
(10) Pub. No.: US 2016/0154808 A1
(43) Pub. Date: Jun. 2, 2016

(54) Location Based Mutual Activity Matching System and Method

(71) Applicant: Adekunle Ayodele, Snellville, GA (US)

(72) Inventor: Adekunle Ayodele, Snellville, GA (US)

(21) Appl. No.: 14/948,529

(22) Filed: Nov. 23, 2015

Related U.S. Application Data
(60) Provisional application No. 62/085,602, filed on Nov. 30, 2014.

(51) Int. Cl. G06F 17/30

(52) U.S. Cl. CPC G06F 17/3087

(57) ABSTRACT

A system and method for matching individual users based on shared activity preference and current geographic location. The method includes the steps of a communications device determining a geographic location of a first user, receiving a preferred activity of the first user, querying a database for a second user with the same preferred activity as the first user whose geographic location is within a threshold radius of the first user's location, prompting the first user to accept or decline a match with the second user, and, if the first user accepts the match, commencing a chat session between the first and second user. The system and method allow for real-time matching of individuals nearby to one another who wish to participate in the same activity.

### CROSS REFERENCE TO RELATED APPLICATIONS

This application claims the benefit of U.S. Provisional Application No. 62/085,602 filed on Nov. 30, 2014. The above identified patent application is herein incorporated by reference in its entirety to provide continuity of disclosure.

### BACKGROUND OF THE INVENTION

The present invention relates to systems and methods for matching individual users based on one or more criteria. More specifically, the present invention relates to systems and methods for real-time matching of individuals within a geographic radius based on similar activity preferences.

Many individuals utilize software that matches individual users with one another based on factors such as shared friends, shared hobbies, or shared interests. Currently, matching software only matches users based on preferences that have been pre-recorded by the users and not based on real-time activities. For example, a first user who enjoys nature may be matched with another who enjoys walking, but the first user may not wish to currently engage in that activity. Further, similar types of software applications often provide for matched users to meet at a future time and place. Individuals currently do not have the ability to conduct real-time matching based on a current activity preference. It is therefore desirable to provide a system and method that allows users to match users with one another based on a currently desired activity shared by individual users.

Another drawback of current matching applications is that they do not account for current user geographic location. For example, an application may match two individuals who have each listed on a profile that they live in the same city. However, there is no way of knowing whether one of the individuals is currently in a different geographic location prior to an initiation of contact between the users. This is especially problematic for an individual looking for a match with a user who is currently within a preferred radius of the individual's current geographic location. Therefore, a system and method that matches users who are each currently within a preferred geographic radius of each other is desired.

Current matching software applications also lack built-in safety features. These applications do not include mechanisms for reporting incidents to a trusted contact. In the case of an emergency, or if a first user is matched with another user who then causes the first user to have feelings of unease or discomfort, the first user must try to extricate themselves from the situation, which can be uncomfortable or even dangerous. There is therefore a need for a system and method of matching individuals that provides a safety feature that allows users to relay their current geographic location to trusted contacts.

### SUMMARY OF THE INVENTION

In view of the foregoing disadvantages inherent in the known types of individual matching systems and methods now present in the prior art, the present invention provides a system for matching individual users wherein the same can be utilized for providing convenience for the user when seeking another nearby user with whom to perform a preferred activity.

Therefore, one object of the present is to provide a communications device having a GPS receiver, a processor, and a non-transitory computer readable medium operatively connected to the processor. Also included is a logic stored in the non-transitory computer readable medium that, when executed by the processor, causes the computer system to perform a method. The method includes the steps of determining a geographic location of a first user of the computer system via the GPS, receiving a preferred activity of the first user via an input, and wirelessly querying a database for a geographic location and a preferred activity of a second user, wherein the database has the geographic location of the second user the preferred activity of the second user stored thereon. If the preferred activity of the second user matches the preferred activity of the first user and if the geographic location of the second user is within a threshold radius of the geographic location of the first user, then an additional step of receiving the geographic location information of the second user from the database is performed. The first user is then prompted to accept or decline a match between the first user and the second user.

Another object of the present invention is to provide a system and method for connecting individuals within a particular geographic area who are interested in the same activity, wherein the method provides for the additional steps of receiving a list of trusted contacts via an input and, if a help command is received via an input, then transmitting the current location of the first user to each of the contacts on the designated contacts list.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram of a computer system according to the present invention.

FIG. 2 shows a method of operation according to the present invention.

FIG. 3 shows additional steps of a method of operation according to the present invention.

### DETAILED DESCRIPTION OF THE INVENTION

Reference is made herein to the attached drawings. Like reference numerals are used throughout the drawings to depict like or similar elements of the location and activity based matching system. For the purposes of presenting a brief and clear description of the present invention, the preferred embodiment will be discussed as used for matching individual users within a threshold geographic radius who desire to undergo the same activity. The figures are intended for representative purposes only and should not be considered to be limiting in any respect.

As used herein, “logic” refers to (i) logic implemented as computer instructions and/or data within one or more computer processes and/or (ii) logic implemented in electronic circuitry. As used herein, “computer-readable medium” excludes any transitory signals, but includes any non-transitory data storage circuitry, e.g., buffers, cache, and queues, within transceivers of transitory signals.

According to some embodiments, the operations, techniques, and/or components described herein can be implemented by an electronic device, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more general purpose hardware processors programmed to perform such features of the present disclosure pursuant to program instructions in firmware, memory, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that incorporates hard-wired and/or program logic to implement the techniques and other features of the present invention.

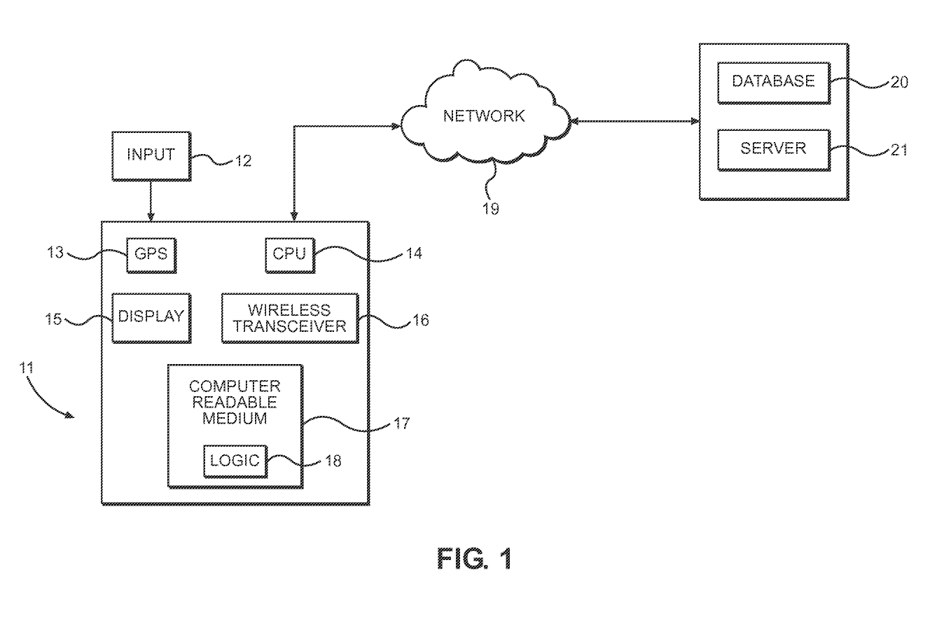

Referring now to FIG. 1, there is shown a diagram of a computer system according to the present invention. The present invention provides a system and method for matching individual users of the system with one another based on geographic proximity and activity preferences. A communications device receives an input of data from a user via an input source such as a keypad or touchscreen. The communications device communicates wirelessly with a database, which has data comprising user preferred activities and locations stored thereon. The communications device receives from the database a list of individual users having matching location and activity information. The communications device then commences a dialogue between the matched individual users.

The present system comprises a communications device 11, such as a smartphone, personal computer, VoIP device, or other mobile or stationary wireless computing device capable of coupling communicatively with a wireless network such as the internet. The communications device 11 of a first user comprises a processor such as a CPU 14, a non-transitory computer readable medium 17 operatively connected the CPU 14, and a logic 18 stored on the non-transitory computer readable medium 17. The communications device 11 further comprises a user input 12, such as a touch screen or a keypad, and a display 15, such as an LCD screen. The user input 12 is utilized for the input of information comprising user preferred activities.

The communications device 11 further comprises a location sensor, such as a GPS receiver 13, configured to determine the geographic location of the communications device 11 via wireless communication between the communications device 11 and one or more GPS satellites. The communications device 11 also comprises a wireless transceiver 16 which is configured to send and receive information wirelessly over a network 19. The communications device 11 is further configured to utilize the wireless transceiver 16 to transfer information wirelessly via the network 19 to a server 21, which is then stored on a database 20.

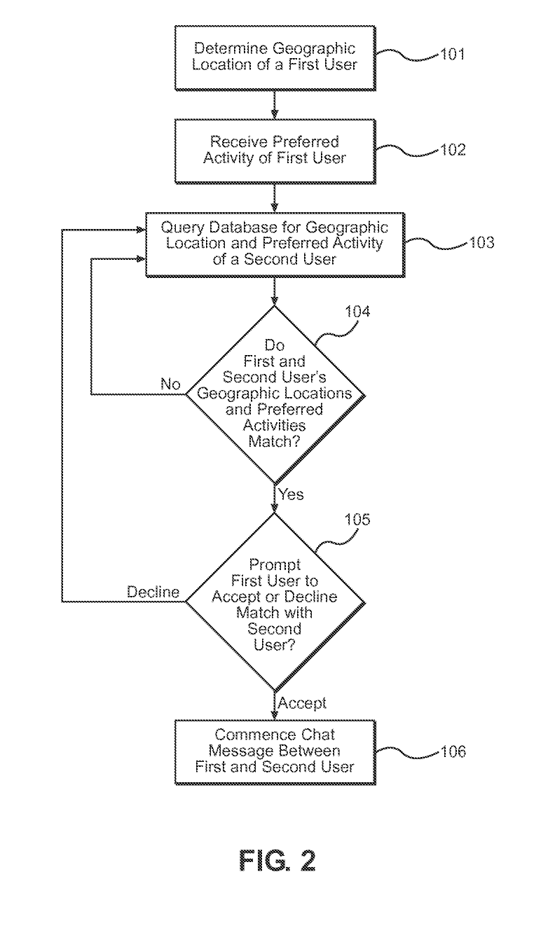

Referring now to FIG. 2, there is shown a method of operation according to the present invention. Performance of each step of the method should be understood to be caused by a logic stored on the computer readable medium of a communication's device belonging to a first individual user. The logic, when executed, causes the communications device to perform each of the steps of the following method.

In a first step, the logic causes the communications device to determine 101 the geographic location of the first user. Determining 101 the geographic location of the first user may be accomplished utilizing the GPS receiver of the communications device of the first user. In a second step, the communications device receives 102 a preferred activity of the first user via an input 12. The first user may utilize the communication device input mechanism such as a keyboard or touchscreen to input preferred activity information. The first user may input any activity or may select an activity from a list of activities that are specific to the location of the user. If the first user is in located at a place of business or specific location, the location of the first user may be determined by comparing the user's current location with the location of existing structures, which may be stored on the database. For example, the first user may choose a preferred activity of “drinks and conversation” if the first user's geographic location is correspondent with the geographic location of the interior of a bar or restaurant: or the first user may input 12 a unique activity.

In a third step, the logic causes the communications device of the first user to query 103 the database with the geographic location and the preferred activity of the first user order to match the first user with a second user. In one embodiment of the invention, the database has current location information and activity preferences of users of the system stored thereon. Each individual user utilizes the described method in order to store location information and activity preference on the database. Further, the database is configured to compare stored user information until it locates a user having a both a geographic location within a threshold radius of the first user and a preferred activity that is the same as the first user's. The server may then send that user's information to the first user.

In an alternate embodiment of the invention, the communications device of the first user may receive the information of a second user stored on the database from the server. In this embodiment of the invention, the logic of the communications device of the first user determines 104 whether the second user has the same geographic location and activity preference as the first user. It is contemplated that the first user may choose the threshold radius relative to the first user's geographic location. In keeping with the previous example of the first user being located in a bar, the first user may confine the search to only other users located in the same bar or may expand the search radius to an area surrounding the bar. If it is determined 104 that the first and second user location and activity do not match, then the logic repeats the query 103 to the database for the location and activity information of another user until a match is found.

Once a match is found, the logic prompts 105 the first user to accept or decline the match with the second user. For example, a person within the desired radius of the first user who also has a preferred activity of “drinks and conversation” will be displayed on the display of the communications device of the first user. Additional information regarding the second user such as an image or video of the second user or other personal information may be displayed on the display. The first user may decline the match with the second user, which causes the first user's communication device to again query 103 the database for a different second user whose geographic location and preferred activity matches that of the first user. If the first user accepts the match with the second user, then a chat session is commenced 106 between the first and second user. The chat session commenced 106 may include features such as video messaging, text messaging, and image sharing.

It is further contemplated that in order to be a user of the present invention, a user must first create a profile video or picture. The profile video or picture is stored on the database where it may be verified to be an accurate representation of the user. One or more requirements for verification may be used. For example, the requirement for verification may include providing additional information such as birth date and comparing the additional information to official records. If the verification requirement is met, the user receives a confirmation from the database. The user may proceed to the step of determining 101 the geographic location of the user.

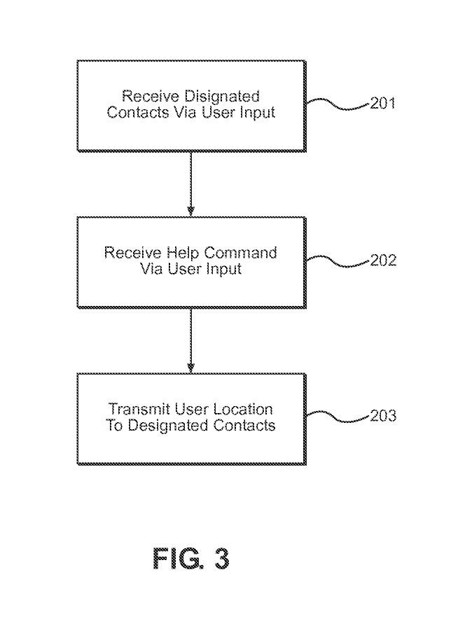

Referring now to FIG. 3, additional steps according to the present method are shown. The present computer system and method further provides a user with the ability to notify known contacts of the user's location. In one embodiment, the method comprises additional steps of the communications device receiving 201 one or more designated contacts via an input. The designated contacts may be those the user may wish to contact during an emergency. In a second step, if the communications device receives 202 a help command via a user input, the location information of the user is wirelessly transmitted 203 to the previously determined designated contacts. For example, if a user is in an uncomfortable or dangerous situation, the user may input a help command, which then causes the communications device to automatically notify emergency contacts of the user's location without requiring additional input.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A communications device comprising:
a GPS receiver;
a processor;
a non-transitory computer readable medium operatively connected to the processor;
a logic stored in the non-transitory computer readable medium that, when executed by the processor, causes the communications device to perform a method, the method comprising the steps of:
determining a geographic location of a first user of the computer system via the GPS receiver;
receiving a preferred activity of the first user;
querying a database with the geographic location and a preferred activity, wherein the database has the geographic location of a second user the preferred activity of a second user stored thereon;
matching the first user to the second user if the preferred activity of the first user matches the preferred activity of the second user and the geographic location of the first user is within a threshold range of the geographic location of the second user;
if a match between the first user and the second user is determined, receiving the geographic location of the second user;
displaying the location of the second user; and
prompting the first user to accept or decline the match.

2) The computer system of claim 1, comprising the additional steps of:
if the first user accepts the match, then commencing a chat session between the first user and the second user.

3) The computer system of claim 1, comprising the additional steps of:
sending a recorded profile video of the first user to the database;
if the profile video meets a requirement, then receiving a notification from the database that the profile video of the first user has been validated.

4) The computer system of claim 1, comprising the additional steps of:
receiving one or more designated contacts;
if the first user inputs a help command, then wirelessly sending the geographic location of the first user to the one or more designated contacts.

5) The computer system of claim 1, comprising the additional steps of:
if a new geographic location of the first user exceeds the threshold radius of the initially determined geographic location of the first user, then wirelessly sending the new geographic location of the first user to the database.

6) A non-transitory computer readable medium that, when executed by a processor of a computer system, causes the computer system to perform a method, the method comprising the steps of:
determining a geographic location of a first user of the computer system via the GPS receiver;
receiving a preferred activity of the first user;
querying a database with the geographic location and a preferred activity, wherein the database has the geographic location of a second user the preferred activity of a second user stored thereon;
matching the first user to the second user if the preferred activity of the first user matches the preferred activity of the second user and the geographic location of the first user is within a threshold range of the geographic location of the second user;
if a match between the first user and the second user is determined, receiving the geographic location of the second user;
displaying the location of the second user; and
prompting the first user to accept or decline the match.

7) The non-transitory computer readable medium of claim 7, comprising the additional steps of:
if the first user accepts the match, then commencing a chat session between the first user and the second user.

8) The non-transitory computer readable medium of claim 7, comprising the additional steps of:
sending a recorded profile video of the first user to the database;
receiving a notification from the database that the profile video of the first user has been validated.

9) The non-transitory computer readable medium of claim 7, comprising the additional steps of:
receiving one or more designated contacts;
if a help command is received, then wirelessly sending the geographic location of the first user to the one or more designated contacts.

10) The non-transitory computer readable medium of claim 7, comprising the additional steps of:
if a new geographic location of the first user exceeds the threshold radius of the initially determined geographic location of the first user, then wirelessly sending the new geographic location of the first user to the database.

11) A computer-implemented method comprising the steps of:
determining a geographic location of a first user of the computer system via the GPS receiver;
receiving a preferred activity of the first user;
querying a database with the geographic location and a preferred activity, wherein the database has the geographic location of a second user the preferred activity of a second user stored thereon;
matching the first user to the second user if the preferred activity of the first user matches the preferred activity of the second user and the geographic location of the first user is within a threshold range of the geographic location of the second user;
if a match between the first user and the second user is determined, receiving the geographic location of the second user;
displaying the location of the second user; and
prompting the first user to accept or decline the match.

12) The computer-implemented method of claim 13, comprising the additional steps of:
if the first user accepts the match, then commencing a chat session between the first user and the second user.

13) The computer-implemented method of claim 13, comprising the additional steps of:
sending a recorded profile video of the first user to the database;
receiving a notification from the database that the profile video of the first user has been validated.

14) The computer-implemented method of claim 13, comprising the additional steps of:
receiving one or more designated contacts;
if a help command is received, then wirelessly sending the geographic location of the first user to the one or more designated contacts.

15) The computer-implemented method of claim 13, comprising the additional steps of:
if a new geographic location of the first user exceeds the threshold radius of the initially determined geographic location of the first user, then wirelessly sending the new geographic location of the first user to the database.
